(19) United States
(12) Patent Application Publication
(10) Pub. No.: US 2018/0052973 A1
(43) Pub. Date: Feb. 22, 2018

(54) System and Method for Searching Meridian Information

(71) Applicant: Chui Ping Hu, Taichung City (TW)

(72) Inventor: Chui Ping Hu, Taichung City (TW)

(21) Appl. No.: 15/680,160

(22) Filed: Aug. 17, 2017

(30) Foreign Application Priority Data
Aug. 19, 2016 (TW) 105126835

(51) Int. Cl. G06F 19/00; G06F 17/30

(52) U.S. Cl. CPC G06F 19/3437; G06F 17/30589; G06F 19/324; G06F 17/30601; G06F 17/30554

(57) ABSTRACT

A method for searching meridian information comprising the steps of preparing a hierarchical database comprising of data related to human body meridians, systems, organs, diseases and symptoms, preparing a dynamic meridian map, said dynamic meridian map comprising of a meridian route passing through a model of the human body, a flashing point wherein said flashing point moves along the meridian route and a plurality of fixed points indicating acupoints on the meridian route and associating the dynamic meridian map with the meridians, systems, organs, diseases and symptoms in the hierarchical database for allowing the use of the meridians, systems, organs, diseases and symptoms as an index for searching meridian information and displaying the dynamic meridian map corresponding to the searched meridians, systems, organs diseases and symptoms.

### BACKGROUND

### Field of the Invention

The present invention relates to a system and a method for searching meridian information, in particular to a system and a method for searching meridian information, which can display dynamic meridian maps of a human body, and meridian information associated with diseases, such as maps and names of meridians and acupoints.

Related Art

According to the meridian (generally referring to channel or vessel) theory, there are close relations between channels and vessels. A human body is an organism composed of different parts cooperating with each other. Any duty cannot be performed by any one organ or any one muscle alone. Various channels, or channels and organs are associated with each other by vessels. Therefore, interactions between them, and intersections of their routes may have a strong connection with a harmonious operation of human functions. Since the meridians exist everywhere in the human body, various conditions of the human body, disease causes and symptoms are all associated with meridians, and organs or parts which they pass through. A meridian may pass through many organs or parts of the human body, and there may be one or more different meridians passing through an organ or a part of the body. A disease may be associated with several meridians. Therefore, it is important for the understanding and application of the meridian theory to health or treatment to know relations between diseases and meridians and which organs or parts a meridian may pass through.

The acupoints on the meridians play important roles for treatment and health, and are widely applied to massage and acupuncture. Conventionally, static lines or marks are used to illustrate routes of meridians to assist in understanding and application of meridians theory. Since information or data regarding association between various diseases and meridians and acupoints are very comprehensive and complicated, a user cannot fully and easily understand the association between various diseases and meridians, and which meridians may pass through each detailed parts of the human body. Therefore, what is needed is a system and method for searching meridian information containing images or text data about diseases and associated meridians.

### SUMMARY OF THE INVENTION

In light of the above, the present invention discloses a system and method for efficiently and accurately providing dynamic meridian maps and information about meridians and their integration with organs/systems, parts of a human body, and their association with various diseases.

According to one aspect of the invention, a method for searching meridian information comprises the steps of : preparing a hierarchy database comprising of data of meridians, systems, organs, detailed parts of the systems or organs of a human body, diseases and symptoms, which are associated with each other so that the systems or organs, the diseases, the detailed parts of the systems or organs can be used as an index for searching meridian information; preparing a dynamic meridian map with a meridian route passing through the human body, a flashing mark having a second color and moving along the route, and a plurality of marks indicating acupoints on the meridian route; and associating the dynamic meridian map with the diseases, the symptoms, and the meridians in the hierarchy database so as to be able to retrieve or display the dynamic meridian map corresponding to the diseases, the symptoms, and the meridians used as the index for searching.

According to another aspect of the invention, the hierarchy database is classified into a parent class, a subclass, and a derived class from high to low, the systems and organs of the human body belong to the parent class, the diseases and the symptoms and their associated meridians belong to the subclass, the detailed parts of the systems and the organs and their corresponding meridians belong to the subclass, and items of information about other symptoms or causes associated with the diseases, the symptoms and the meridians belong to the derived class.

The hierarchy database is classified into a parent class, a subclass, and a derived class from high to low. The systems and organs of the human body belong to the parent class, the diseases and the symptoms and their associated meridians belong to the subclass, the detailed parts of the systems and the organs and their corresponding meridians belong to the subclass, and items of information about other symptoms or causes associated with the diseases and/or the symptoms and their corresponding meridians belong to the derived class.

According to the invention, a plurality of coordinates corresponding to a plurality of locations along the meridian route in the human body are obtained for forming the dynamic meridian maps, based on simulation of a structure ratio of the human body model, and relative positions or relations between the organs and the parts, and generates a plurality of flashing marks on the coordinates of the meridian route sequentially so as to form the dynamic meridian map. These coordinates may be two- or three-dimensional ones.

According to still another embodiment of this invention, an electronic device capable of searching median information is selected from one of a notebook computer, a personal digital assistant, a server, a smart phone, a tablet computer, and a desk computer.

The present invention can provide accurate and dynamic meridian maps, display the meridian maps made in accurate ratio according to the diseases/symptoms, or meridians, and provide meridian information corresponding to systems or organs, organs/associated parts, diseases/symptoms, etc., which are used as an index for searching.

### BRIEF DESCRIPTION OF THE DRAWINGS

The features, aspects, and advantages of this invention will be better understood by reading the detailed description which follows, taken in conjunction with the accompanying drawings. The drawings are not necessarily to scale, emphasis instead generally being placed upon illustrating the principles of the invention, in which:

FIG. 1 is a flowchart illustrating a method for searching meridian information according to the embodiment of this invention;

FIG. 2 illustrates a three-dimensional map of a human body according to the embodiment of this invention;

FIG. 3 illustrates a two-dimensional map of a human body according to the embodiment of this invention;

FIG. 4 illustrates integrated information containing a meridian map inquired according to a disease such as “myopia”; and

FIG. 5 is a block diagram illustrating a system for searching median information according to the embodiment of this invention.

### DETAILED DESCRIPTION

In the following detailed description, numerous details are disclosed to help understanding of this invention. Embodiments of this invention are illustrated with reference to the accompanying drawings, but it should be understood that this invention is not limited to the illustrated embodiment. On the contrary, various substitutes, modifications, and equivalents are all encompassed by the spirits and scope of this invention defined in claims which follow.

As used in this specification, the term “median information” may include dynamic and still median maps, acupoint maps, data of channels and vessels (generally referred to as meridians) associated with body systems/organs or respective parts, diseases/symptoms and so on, but not limited to image data or text data alone. Herein, the term “meridian” refers to a median of the human body, and includes, for example, lung meridian, large intestine meridian, stomach meridian, spleen meridian, heart meridian, small intestine meridian, bladder meridian, kidney meridian, Sanjiao meridian, gallbladder meridian, liver meridian, directing vessel, and governing vessel.

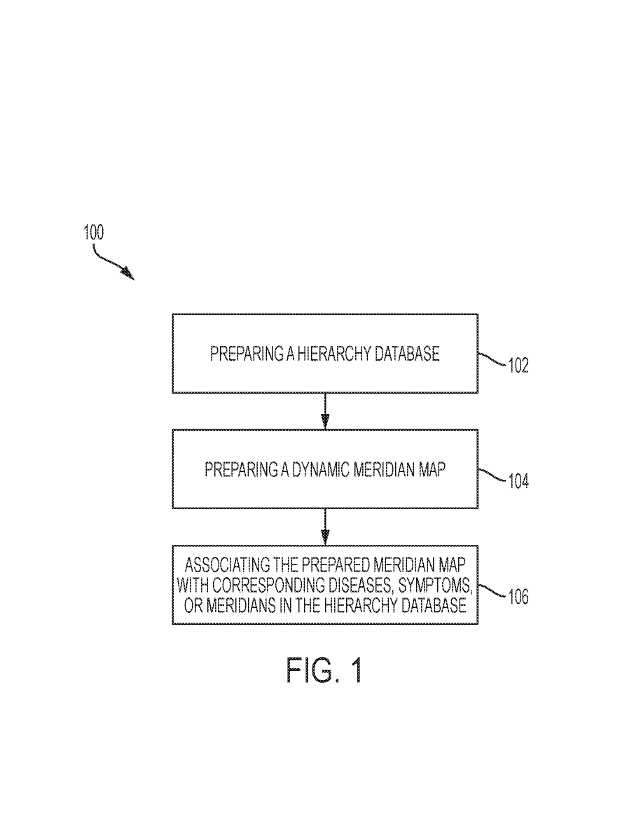

First, the method 100 for searching meridian information according to an embodiment of this invention will be illustrated with reference to FIG. 1. As shown in step 102 in FIG. 1, a database storing association information of meridian, organs, parts, or diseases arranged in a hierarchical manner is provided. In the hierarchical database according to the embodiment, the highest level is the parent class, a secondary level next to the highest level is the subclass, and a third level lower than the secodary level is the derived level, and so on. For example, systems of a human body include the circulatory system, the respiratory system, the digestive system, the urinary system, the genital system, muscles, the skeletal system, the endocrine system, the brain, the nervous system, the cardiovascular system, the lymphoid system, the sense organ, etc. According to this embodiment, these systems or organs or their parts are classified as the parent class. For example, eyes or respiratory system are classified into the parent class, and diseases and/or main symptoms such as myopia or cold, and corresponding meridians are classified as the subclass. Other symptoms or causes related with the diseases and/or main symptoms are classified into the derivied class. For example, eye pain and headache accompanying the cold and associated meridians are classified as the derivied class. An example of the hierarchical database storing information with “eye” and “respiratory system” classfied as the parent class is listed as follows.

⊚Eye
Upper eyeslid: Spleen Meridian
Lower eyeslid: Stomach Meridian
Inside and outside corner of the eyes: Heart Meridian
Eye whites: Lung Meridian
Iris: Liver Meridian
Pupil: Kidney Meridian
Connecting part connecting the rear portions of eyes and the brain: Liver Meridian, Heart Meridian
Through the outer corner of the eyes: Small Intestine Meridian, Gallbladder Meridian, Sanjiao Meridian
Through the inner corner of the eyes: Stomach Meridian, Small Intestine Meridian, Bladder Meridian
Under the eyes: Governing Vessel, Directing Vessel
Jelly-like gum: Lung Meridian
Floaters: Liver Meridian, Kidney Meridian
Eyeslid jump: Bladder Meridian, Gallbladder Meridian, Sanjiao Meridian, Stomach Meridian
Dry eyes: Gallbladder Meridian, Sanjiao Meridian
Presbyopia: Liver Meridian, Small intestine Meridian
Astigmatismtriple: Sanjiao Meridian, Stomach Meridian, Heart Meridian, Liver Meridian, Kidney Meridian
Myopia: Bladder Meridian, Gallbladder Meridian, Sanjiao Meridian, Stomach Meridian, Liver Meridian, Kidney Meridian, Governing Vessel, Large Intestine Meridian
Amblyopia: Bladder Meridian, Gallbladder Meridian, Sanjiao Meridian, Stomach Meridian, Liver Meridian, Spleen Meridian
Cataract, glaucoma: Stomach Meridian, Liver Meridian, Kidney Meridian, Bladder Meridian, Gallbladder Meridian, Governing Vessel
Dark circles, eyes band: Stomach Meridian, Kidney Meridian, Directing Vessel
Crow's feet: Stomach Meridian, Sanjiao Meridian, Heart Meridian
Photophobia: Liver Meridian, Kidney Meridian

⊚Respiratory system
Cold: Master Meridian: Bladder Meridian
   1 eyes pain, headache: Bladder Meridian, Gallbladder Meridian
   2 Headache: Directing Vessel, Stomach Meridian
   3 Nasal congestion, allergic rhinitis: Large Intestine Meridian
Cough with phlegm: Liver Meridian, Large intestine Meridian, Lung Meridian, Bladder Meridian

As illustrated above, “eye” and “respiratory system” are classified as the parent class in this database. A plurality of items of information associated with eyes, such as “Myopia: Bladder Meridian, Gallbladder Meridian, Sanjiao Meridian, Stomach Meridian, Liver Meridian, Kidney Meridian, Governing Vessel, Large Intestine Meridian”, are classified as the sub-class. Those items of information associated with the respiratory system classified as the parent class, such as “Cold: Master Meridian Bladder Meridian” and “Cough with phlegm: Liver Meridian, Large intestine Meridian, Lung Meridian, Bladder Meridian” are categorized as the subclass in this database. The items of information “1 eyes pain, headache: Bladder Meridian, Gallbladder Meridian”, “2 Headache: Directing Vessel, Stomach Meridian” and “Nasal congestion, allergic rhinitis: Large Intestine Meridian” belongs to the derived class. For simplicity, only a very small portion of the database prepared according to this embodiment is shown here. It should be understood that this invention is not limited to this. The database according to this embodiment is open, i.e., the database can be expanded or increased to be a very huge database as necessary.

Besides, the items of information associated with eyes detail meridians passing through each parts of eyes. For example, the item “Upper eyelid: Spleen Meridian” indicates that there is spleen meridian passing through the upper eyelid, the item “Lower eyelid: Stomach Meridian” indicates that there is stomach meridian passing through the lower eyelid, the item “Inside and outside corner of the eyes: Heart Meridian” indicates that there is heart meridian passing through inside and outside corner of the eyes, and so on. For simplicity, only parts of eyes are exemplified, but this invention is not limited to this. Actually, this invention can provide meridian information associated with detailed parts of organs, systems or parts of the body.

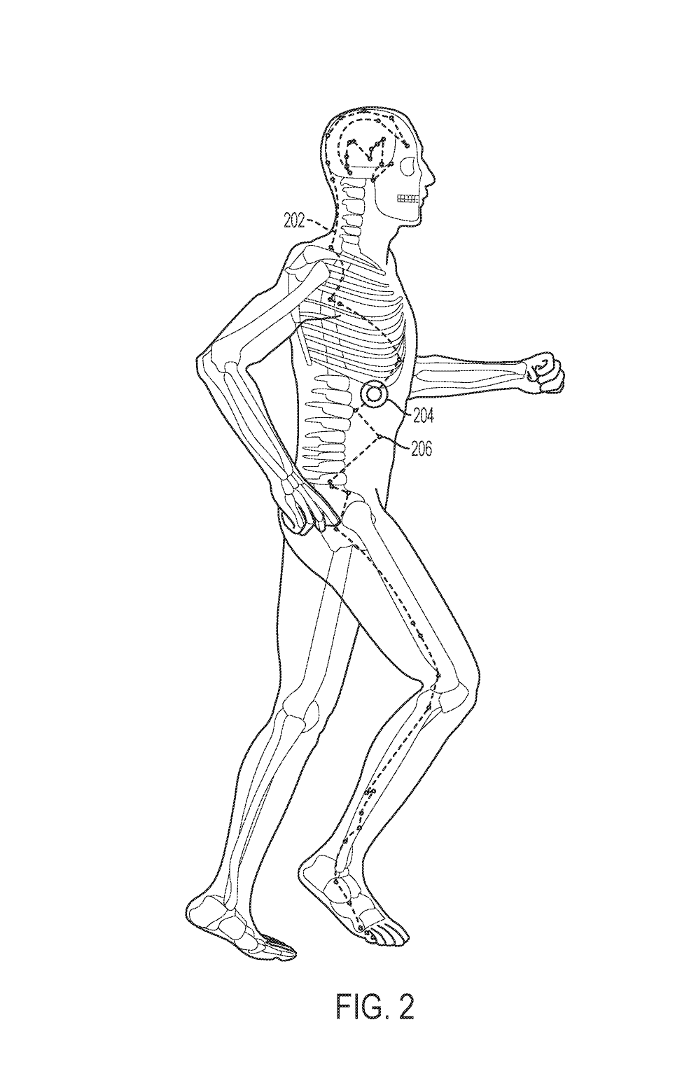

In step 104, a dynamic meridian map is prepared. FIG. 2 illustrates a three-dimensional routes of the gallbladder in the human body according to this invention. As shown in FIG. 2, a curve 202 indicates the route of the gallbladder meridian, and a flashing mark 204 moves along the gallbladder meridian to indicate that the gallbladder meridian passes through associated parts of the human body. In the figure, the flashing mark is formed with two different circles which are concentric, with the inner one being a concrete circle and being surrounded by the outer one. The gallbladder meridian curve 202 may be displayed with a color such as yellow, and the flashing mark may have a different color such as red. However, any appropriate color which provides a contrast may be used. The flashing mark is not restricted to the concentric circles shown in the figure, but can take other forms as may be appropriate. A plurality of spots (for example, 206) are to represent various acupoints on the meridian.

According to an embodiment, each dynamic meridian map of the human body is made according to a ratio of structure of a human body model. As shown in the meridian map in FIG. 2, positions of meridians and acupoints relative to the human parts such as bones, muscles, and organs are clearly shown. Not only the positions of the meridians relative to parts of the human body but also the lengths of medians are made accurately and precisely based on calculation so as to exactly conform to the ratio of the human body. Two or three-dimensional coordinates corresponding to locations in the body which meridians pass through are obtained based on simulation of the ratio of the structure of the human body model, and relative positions or relationships between organs or parts. Then, these two or three-dimensional coordinates are connected to form accurate and precise meridian maps including body, meridian curves, acupoints, and so on, such as is illustrated in FIG. 2. The locations of acupoints shown on meridian routes are also very accurate and precise, because the meridian routes are formed by connecting the plurality of coordinates calculated very accurately and precisely. For displaying meridian maps dynamically, a visual effect is made in such a manner that a plurality of identical flashing marks on two- or three-dimensional coordinates along the meridians are displayed sequentially in a flickering manner, so as to make the flashing mark look like it is moving along median routes. Accordingly, the dynamic median maps are formed. According to an embodiment of this invention, two- or three-dimensional coordinates are used to form two- or three-dimensional meridian maps correspondingly. The above description is made with reference to the three-dimensional meridian map, but this invention is not limited to this. The description which follows will be made based on the two-dimensional map, but the user can select two- or three-dimensional meridian maps to meet his/her requirements.

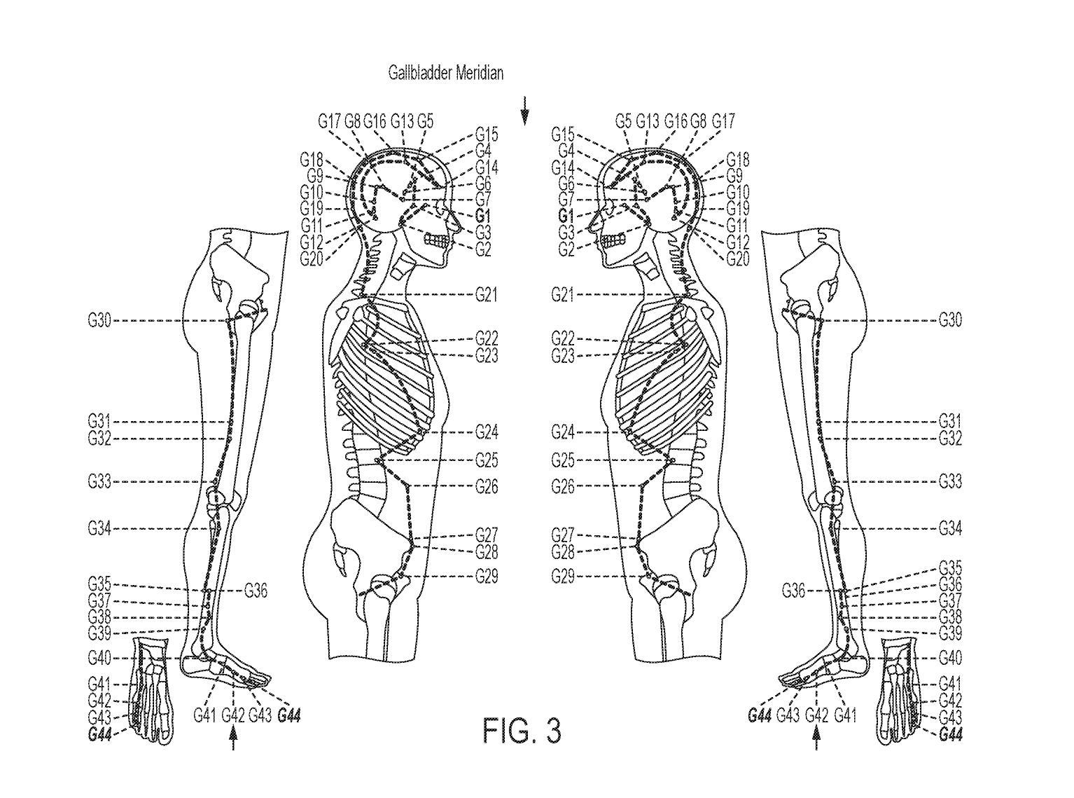

Because some acupoints on the meridians need to be massaged or acupunctured for some diseases or symptoms in many cases, it is necessary to know the exact locations of acupoints on the meridian, and to know which acupoints associated with diseases or symptoms are to be massaged or acupunctured. Therefore, in the meridian maps formed according to the embodiment of this invention, the acupoints can be displayed as spots 206 on the exact locations along the meridians, based on the ratio of the structure of the human body model, relative locations between acupoints, and those exact coordinates. FIG. 3 shows a two-dimensional gallbladder meridian map according to the embodiment of this invention. As illustrated in FIG. 3, the locations and names of a plurality of acupoints on the meridian are clearly indicated. From FIG. 3, names of acupoints on the gallbladder meridian, and especially their exact locations in the body can be known.

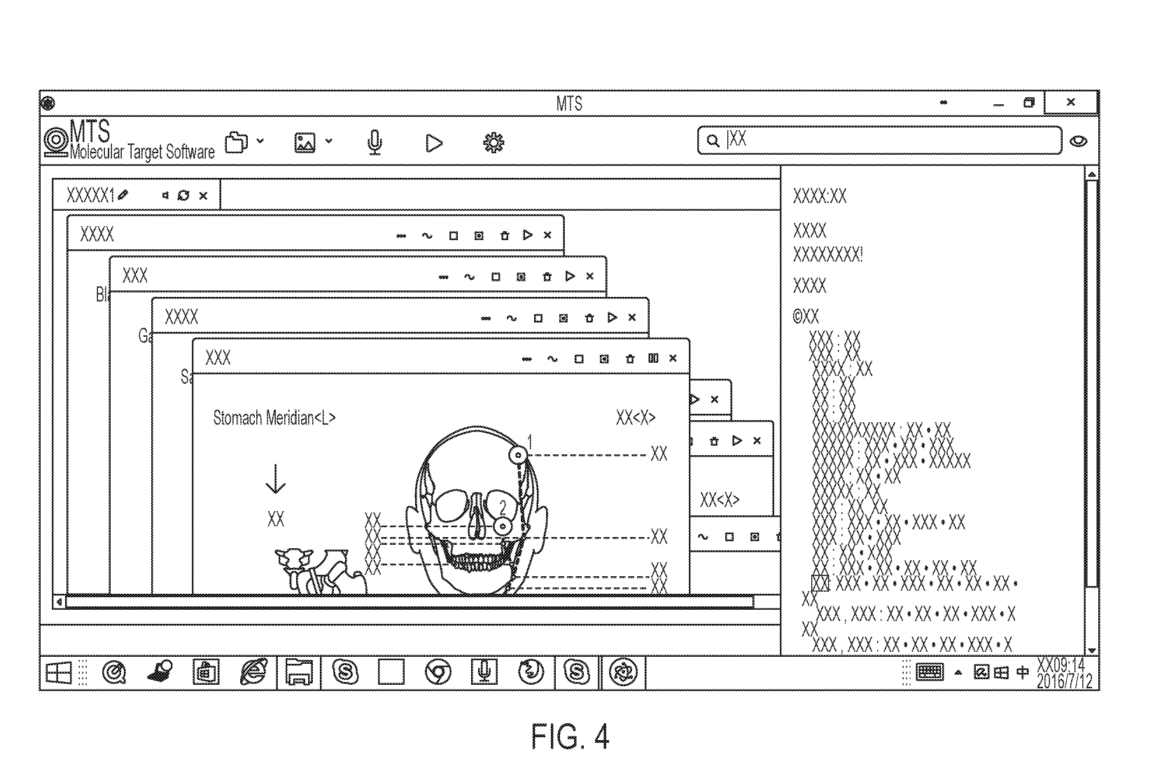

In step 106, the acupoints on meridian maps are associated with the corresponding diseases/symptoms or names of meridians in the hierarchical database so that the corresponding meridian maps can be displayed with the diseases or symptoms, which are used as an index for searching. Upon selection of meridians, the dynamic meridian maps corresponding to the selected meridians can be displayed. For example, if the word “myopia” is used as the keyword to search, then as shown in FIG. 4, the associated acupoints on stomach meridian and the hierarchical database with eye as the parent class would be displayed. If any meridian in the database is selected, then the dynamic meridian map corresponding to that selected meridian will be displayed. For example, if the gallbladder in the information item “Myopia Bladder Meridian, Gallbladder Meridian, Sanjiao Meridian, Stomach Meridian, Liver Meridian, Kidney Meridian, Governing Vessel, Large Intestine Meridian” is selected, then the dynamic Gallbladder Meridian Map as shown in FIG. 2 will be displayed. As clearly seen from the gallbladder meridian map, we can see that the Gallbladder Meridian sequentially passes through associated organs and/or parts of the human body. It is also possible to directly input the name of a meridian to search and display the corresponding dynamic meridian map.

Accordingly, the method according to this invention allows diseases/symptoms or meridian names such as myopia to be used as the keyword to search or display the meridian maps having accurate ratio, and to use the systems, organs, associated parts, diseases, or symptoms as the index for searching their corresponding meridian information.

According to another embodiment, a computer-readable storing medium records a program, which will cause a computer to perform the method according to this invention for searching meridian information, when executed.

In the forgoing, the method for searching meridian information according to this invention has been illustrated by way of example. However, it should be noted that the steps of the embodiment can be executed in any order, in parallel, or individually, without being limited to the illustrated order. The illustrated embodiments of this invention may be practiced with a software, firmware, hardware, or any combination of them.

According to still another embodiment, the method of this invention can be practiced with an electronic apparatus such as a notebook computer, a personal digital assistant, a server, a smart phone, a tablet computer, and a desk computer. The electronic apparatus can load a program from an external device, via a network, or from an embedded storing device in order to perform the method of this invention. The program which can cause the electronic apparatus to perform the method of this invention may be embedded in the storing device of the electronic apparatus or recorded in a computer-readable storing medium such as a hard disk, a magneto-optical disk, a DVD, a flash disk, and other similar storage mediums commonly known in the art. The electronic apparatus will be described further in the following description.

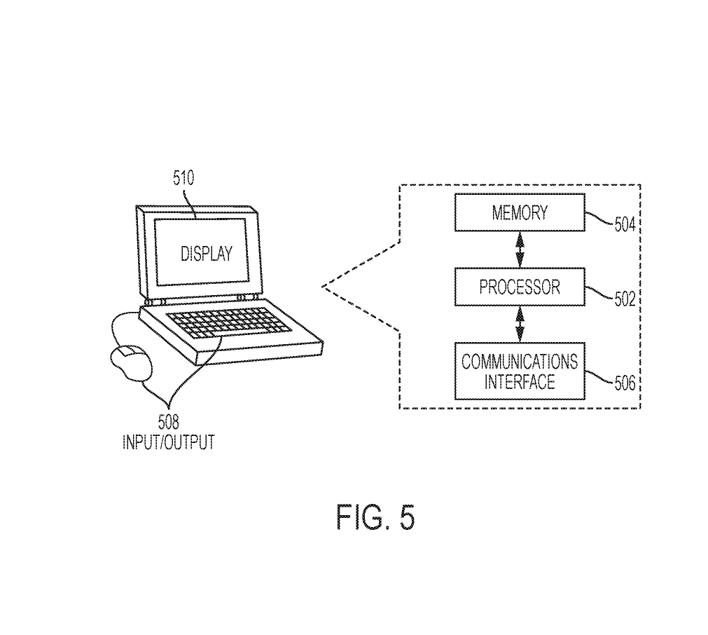

FIG. 5 shows an exemplary electronic apparatus 500. As shown in FIG. 5, the electronic apparatus 500 includes a processor 502, a memory device 504 for storing data or program codes, a communication interface 506 for communication with an external device or network, an input/output device 508, and a display 510 for displaying an operation page and inquired data. A program residing in the memory device 504 may be a program loaded from outside or embedded therein, and may cause the electronic apparatus to perform the method according to this invention. The electronic apparatus 500 can operate to display an operation page such as the one shown in FIG. 4 on the display 510, so that the user can input commands or data for operation by means of the input/output device 508 such as a keyboard, a mouse, an audio input device such as a microphone, a screen keypad, and a touch device, or via the communication interface 506 (wire or wireless communication interface), an external device or network. The processor 502 can execute the method for searching meridian information according to this invention based on the input data and a predetermined program, and may display on the display 510 results such as inquired data or the dynamic meridian map as shown in FIG. 5. The display 510 may be a touch screen so that the electronic apparatus may be operated in a touching manner.

The present invention can provide accurate and dynamic meridian maps, search the meridian maps with the diseases/symptoms, or use meridians as an index for searching, and provide information about which meridians appear in each part of the body, and meridian information corresponding to systems or organs, organs/associated parts, diseases/symptoms.

Accordingly, this invention can provide accurate and dynamic meridian maps, display the accurate and dynamic maps having accurate ratio according to diseases/symptoms, or meridians, and provide meridian information corresponding to systems, organs, or organs/associated sub-parts of the human body, diseases/symptoms, etc. which are used as an index for searching.

While the invention has been particularly shown and described with reference to specific embodiments, the above description is illustrative only, but not restrictive to this invention. It should be understood by those skilled in the art that various changes may be made without departing from the spirit and scope of the invention, and such changes all fall within the scope defined by the claims. The scope of the invention is indicated by the appended claims.

What is claimed is:

1. A system and method for searching meridian information, comprising the steps of:
(a) preparing a hierarchical database comprising of data related to human body meridians, systems, organs, diseases and symptoms, and their association with each other so that the meridians, systems, organs, diseases, and symptoms can be used as an index for searching meridian information;
(b) preparing a dynamic meridian map, said dynamic meridian map comprising of (i) a meridian route passing through a model of the human body or of parts of the human body; (ii) a flashing point wherein said flashing point moves along the meridian route; and (iii) a plurality of fixed points indicating acupoints on the meridian route; and
(c) associating the dynamic meridian map with the meridians, systems, organs, diseases and symptoms in the hierarchical database for allowing the use of the meridians, systems, organs, diseases and symptoms as an index for searching meridian information and displaying the dynamic meridian map corresponding to the searched meridians, systems, organs diseases and symptoms.

2. The system and method of claim 1, wherein the flashing point is of a contrasting color.

3. The system and method of claim 1, wherein the hierarchical database is classified into a parent class, a subclass, and a derived class ordered from top down.

4. The system and method of claim 3, wherein systems and organs of the human body are in the parent class, diseases, symptoms and their associated meridians are in the subclass, detailed parts of the systems and the organs and their corresponding meridians belong to the subclass, and items of information about other symptoms or causes associated with the diseases, the symptoms and meridians belong to the derived class.

5. The system and method of claim 1, wherein the step of preparing a dynamic meridian map comprises of obtaining a plurality of coordinates corresponding to a plurality of locations along the meridian route in the human body for creating the dynamic meridian maps based on simulation of a structure ratio of the human body and relative positions or relations between the organs and the parts, and generating a flashing point moving along the coordinates of the meridian route sequentially so as to form the dynamic meridian map.

6. The system and method according to claim 5, wherein the coordinates are two- or three-dimensional.

7. The system and method according to claim 6, wherein the positions of the fixed points are determined based on the coordinates.

8. A system for searching meridian information, comprising:
(a) a hierarchical database comprising of data related to human body meridians, systems, organs, diseases and symptoms, and their association with each other so that the meridians, systems, organs, diseases, and symptoms can be used as an index for searching meridian information
(b) a dynamic meridian map associated with the meridians, systems, organs, diseases and symptoms in the hierarchical database for allowing the use of the meridians, systems, organs, diseases and symptoms as an index for searching meridian information and displaying the dynamic meridian map corresponding to the searched meridians, systems, organs diseases and symptoms, said dynamic meridian map comprising: (i) a meridian route passing through an illustration of the human body or illustrations of parts of the human body; (ii) a flashing point wherein said flashing point moves along the meridian route; and (iii) a plurality of fixed points indicating acupoints on the meridian route;
(c) an electronic device, said electronic device comprising of (i) a processor; (ii) a memory; (iii) a communication interface for communicating with an external device or a network; (iv) an input and output device; and (v) a display; and
(c) an application program comprising of instructions, the instructions causing the searching and display of meridian information.

9. The system of claim 8, wherein the electronic device is selected from the group consisting of a handheld computer, a personal digital assistant, a smart phone, a laptop computer, and a desk computer.

10. A non-transitory computer-readable medium for searching meridian information, comprising instructions stored thereon, that when executed on a processor, perform the steps of:
(a) preparing a hierarchical database comprising of data related to human body meridians, systems, organs, diseases and symptoms, and their association with each other so that the meridians, systems, organs, diseases, and symptoms can be used as an index for searching meridian information;
(b) preparing a dynamic meridian map, said dynamic meridian map comprising of (i) a meridian route passing through a model of the human body or of parts of the human body; (ii) a flashing point wherein said flashing point moves along the meridian route; and (iii) a plurality of fixed points indicating acupoints on the meridian route; and
(c) associating the dynamic meridian map with the meridians, systems, organs, diseases and symptoms in the hierarchical database for allowing the use of the meridians, systems, organs, diseases and symptoms as an index for searching meridian information and displaying the dynamic meridian map corresponding to the searched meridians, systems, organs diseases and symptoms.
